(19) United States
(12) Patent Application Publication
(10) Pub. No.: US 2024/0359261 A1
(43) Pub. Date: Oct. 31, 2024

(54) Method for creating a producing on a workpiece for various laser devices

(71) Applicant: Trotec Laser GmbH, Marchtrenk (AT)

(72) Inventors: Paul HAGER, Bad Wimsbach (AT); Alexander REITER, Lichtenberg (AT)

(21) Appl. No.: 18/291,123

(22) PCT Filed: Jul. 20, 2022
(86) PCT No.: PCT/AT2022/060258

§ 371 Date: Jan. 22, 2024

(30) Foreign Application Priority Data
Jul. 22, 2021 (AT) A50607/2021

(51) Int. Cl. B23K 26/06; B23K 26/0622; B23K 26/082; B23K 26/38; B23K 26/40

(52) U.S. Cl. CPC B23K 26/0626; B23K 26/0622; B23K 26/0643; B23K 26/0648; B23K 26/082; B23K 26/38; B23K 26/40

(57) ABSTRACT

A laser device and a method for producing a perforation on a workpiece for various laser devices is disclosed. Two beam sources in the form of lasers may be located to act on the workpiece to be processed. The workpiece is deposited in a defined manner on a processing table and a laser beam emitted by the beam source is deflected in the direction of the workpiece and focused for processing. Control is effected via software running in a control unit where the workpiece is processed by adjusting a carriage in the X-Y direction or by adjusting an angle of a mirror. A “perforation” option may be loaded or used such that during processing of the workpiece, a continuous line or incision is formed on an upper side of the workpiece over a defined depth, and indentations or cuts are formed at defined intervals.

### TECHNICAL FIELD

The present disclosure relates to a method for creating a perforation on a workpiece for various laser devices, in particular laser plotters or galvo marking lasers, for cutting, engraving, marking and/or lettering of a workpiece.

### DESCRIPTION OF THE RELATED ART

Laser processing devices in which one or several laser sources are operated in alternating fashion are known from the prior art. Such laser devices include so-called laser plotters, which have an adjustable, belt-driven carriage on which a focusing unit is arranged also adjustably. Preferably, here flat workpieces such as paper, plates, textiles, ballpoint pens, cell phones, tablets, laptops, etc. are processed by a laser, in particular a laser beam, which is conveyed from the laser source via deflection elements to the focusing unit on the carriage and deflected by the focusing unit in the direction of the workpiece.

There are also so-called galvo lasers 2b known, as shown in FIG. 2, in which the laser beam 10 is deflected and positioned above the processing area 8 in the direction of the workpiece 7 via an adjustable mirror 12a.

The two laser device types 1, i.e. the laser plotter and the galvo laser, have a control unit for the control and regulation of all components. Usually, an external component, in particular a laptop, is used to create a graphic or text using commercially available or proprietary software, which is then transferred to the laser device, in particular its controller, in the form of a job. Certain parameters for processing the workpiece can be set on the same or another software program and integrated into the job.

The state of the art already enables a user to select or set the “perforation” function for one or several lines, for which the user is prompted to select a certain percentage of the increase or decrease in the set laser power to form a perforation, so that the perforation is formed by increasing and decreasing the laser power accordingly during the processing of the workpiece. With increased laser power, cutting of the laser through the material, i.e. through the entire material thickness, over a certain travel distance is to be achieved, whereas with minimized laser power, no or only a slight incision or line, respectively, with a certain depth is produced in the material surface of the workpiece. Modern laser plotters or galvo lasers, respectively, can additionally set the length of the individual phases, i.e. the penetration and/or incision, too.

The disadvantage here is that the user can find an optimum setting for creating a perforation only by trying it out several times, or by using his/her experience. Even more so because the setting can change significantly with differing materials and/or material thicknesses. Another disadvantage is that the user wants to know exactly which lines of the graphic and/or text he/she wants to form as perforations in order to set them accordingly.

### SUMMARY OF EMBODIMENTS

The objective of the present disclosure is to create a method for producing a perforation on a workpiece for various laser devices for cutting, engraving, marking and/or labeling a workpiece, in which on the one hand the above-mentioned disadvantages are avoided and on the other hand a high degree of user-friendliness is achieved for forming a perforation on a workpiece.

The objective is achieved by the present disclosure. Advantageous embodiments and/or process measures are described in the dependent claims.

The objective of the present disclosure is achieved by a method for producing a perforation on a workpiece for various laser devices, in particular a laser plotter or galvo marking laser, for cutting, engraving, marking and/or labeling a workpiece, in which by selecting or transferring or activating, respectively, a “perforation” option a predefined power or energy curve for the laser as a function of the set laser power, in particular the basic power and/or the material type and/or material thickness, is loaded or used, so that during the processing of the workpiece, a continuous line or incision, respectively, and indentations or penetrations are formed at defined intervals over a defined depth on an upper side of the workpiece.

The advantage here is that the user can select the type of perforation, in particular the shape of the perforation, by storing special power or energy curves or curve shapes, respectively. Concomitantly, simple and automatic adaptation of the power and energy curve to other parameters, such as the material of the workpiece, the material thickness, etc., and a set laser power, in particular basic power, can be carried out so that a perforation with high quality is produced without the user having to carry out several attempts to find the parameters. Here, users can change the individual parameters at any time and save their own power and energy curves as well. Like the power and energy curves stored as standard, these can then be called up via the software, for which the user can also enter his/her own designation.

Preferably, upon creation of the job for processing the workpiece an analysis process is carried out in which the parameters material type, material thickness, laser power and the power or energy curve are used to determine the parameters for forming the perforation.

The power or energy curve can be displayed in the form of a schematic diagram of a structure for the perforation on the workpiece or in the form of a curve for the power of the laser, allowing the user to make a selection based on the visual representation. Here the parameters for generating the diagram are adapted depending on the parameters power, material type and/or thickness.

Advantageous embodiments are those in which the power of the laser or laser source is adapted to the set “material thickness” parameter, so that a continuous line or incision, respectively, is produced on the surface of the workpiece preferably over the specified depth. This ensures that a nice cutting line is formed on one upper side of the workpiece, while the starting points of the perforation are present on the opposite side.

Advantageous embodiments are those in which the “depth” parameter, preferably in relation to the “perforation” parameter, specifies a percentage value for the “material thickness” parameter, so that an automatic calculation of the actual depth is carried out before or at the start of the process. This enables the user to define the depth of the continuous line on the top of the workpiece in relation to the tool thickness. Subsequently, the laser power is automatically adjusted to the selected power and/or energy curve in order to achieve the depth.

Advantageous embodiments are those in which several different power or energy curves, in particular pulses for the laser sources, are stored to form different perforations, one of which is selected manually by the user or automatically before processing the workpiece. This enables a user to make an easy selection by means of a visual representation of the power curve and/or energy curve. To this end, it is also advantageous if a display image of the perforation thus formed, in particular of the starting points or webs, respectively, is displayed or can be called up. It is particularly advantageous if before or after a machining process the customer can save his or her settings and curve, which the user can then re-open and reuse at any time. To this end, the user can freely label the stored curves and enter and save corresponding comments.

Advantageous embodiments are those in which a power or energy curve, in particular the pulses, is stored using PWM signals with different pulse heights and pulse lengths. This ensures that the workpiece can be processed quickly and easily.

In an advantageous embodiment, the power or energy curves, respectively, in particular rectangular curves with different pulse heights and pulse lengths, are stored. The individual parameters, in particular the pulse heights and pulse lengths, can be changed and set by the user, who can then save them again. As a matter of principle, it is possible to always save and display the setting made most recently when the “perforation” function is called up again, whereby the user can also select the option that the default values specified by the manufacturer are always to be displayed when the “perforation” function is called up again.

Advantageous embodiments are those in which the information and/or the power or energy curve for a perforation is stored or saved, respectively, when the graphic and/or text is created by selecting a defined property, in particular a line type. Thus, the user simply selects the line type or, in the case of an existing graphic or text, changes the corresponding lines to this line type in order to produce a perforation with stored power or energy curves.

Advantageous embodiments are those in which an automatic analysis process is carried out for the graphic and/or text by selecting the “Perforation” option, in which all outer edges of the graphic and/or text or a closed contour with a defined offset or an envelope curve to the enclosed object is marked or changed as the line type for the perforation. This allows the user to create a perforation after creating the graphic and/or text by simply selecting the parameter. Here, the user can adjust the individual lines proposed for perforation as well as the lines that have not been changed by selecting a different line type, i.e. the user can, for example, request further perforations within the graphic and/or text so that these lines are changed to the “Perforation” line type. Activating the “Envelope Curve” function significantly increases user-friendliness, as the envelope curve is created automatically. The user can additionally set a distance so that the envelope curve is generated around the created graphic or text at a specified distance.

Advantageous embodiments are those in which a wide range of options, in particular line types, are stored in the operator software and can be selected. This ensures ease of application for the user, who merely has to select the appropriate line types when producing the text and/or graphics in order to apply the underlying functions, such as “perforation”, i.e. the user selects the line type “perforation or perforation 2 mm, . . . ”, for example, so that a power or energy curve stored for this line type is automatically executed when the machining process is carried out. Of course, the user can change the underlying parameters, such as the power or energy curve, depth, distance, etc. at any time before starting the machining process.

Furthermore, the objective of the present disclosure is achieved by a laser plotter for engraving, marking and/or lettering a workpiece, in which the controller, when the “perforation” option is activated or selected, is designed to operate the lasers or beam sources, respectively, with a power or energy curve in which a continuous line and indentations or penetrations are formed at defined intervals on a surface of the workpiece. The advantage here is that for the first time the user has the option of selecting differing perforations via the stored power or energy curve. This significantly increases the user-friendliness of this type of laser plotter.

However, the objective of the present disclosure is also achieved by a galvo marking laser for engraving, marking and/or lettering a workpiece, in which the controller is designed to operate the lasers or beam sources, respectively, with a power or energy curve when the “perforation” option is activated or selected, in which a continuous line and indentations or penetrations are formed at defined intervals on a surface of the workpiece. The advantage here is that for the first time the user has the option of selecting differing perforations via the stored power or energy curve. In this laser type, too, user-friendliness is likewise significantly increased.

Furthermore, the objective of the disclosure is achieved by a method for producing a perforation on a workpiece for various laser devices, in particular laser plotters or galvo marking lasers, for cutting, engraving, marking and/or labeling a workpiece, in which a perforation line running around the graphics and/or text at a distance is automatically created by activating a parameter, in particular a “perforation envelope curve”. The advantage here is that a cutting line is automatically generated around the created text or graphic, respectively, which can be adjusted by the user at any time if necessary.

Advantageous embodiments are those in which a distance of the circumferential perforation line can be set or the perforation line can be moved manually on the software, in particular adjusted. This enables the user to flexibly adjust the circumferential envelope curve.

Finally, in advantageous embodiments the shape, such as cloud-shaped, oval, adapted, etc., of the perforation line is changed and preset. This significantly increases user-friendliness, as the user can simply select any shape without having to create it by himself/herself. As a matter of principle, it is also possible for the user to create an envelope curve, in particular an envelope curve shape, and then save it so that it can be reused later. It is also possible to import certain shapes.

Embodiments are now described in the form of an exemplary embodiment, whereby it is emphasized that the disclosure is not limited to the exemplary embodiment or solution shown and described, but can be applied to equivalent solutions.

### BRIEF DESCRIPTION OF THE DRAWINGS

FIG. 1 is a schematic representation of a laser device, in particular a laser plotter, for processing a workpiece, simplified, for illustrative purposes only.

FIG. 2 is a further schematic representation of a further laser device, in particular a galvo marking laser, for processing a workpiece with an external component with a “perforation” software interface, simplified, for illustrative purposes only.

FIG. 3 is a sectional view through a workpiece, in particular through a perforation line, with a special power or energy curve, simplified, for illustrative purposes only.

FIG. 4 is a further sectional view through a workpiece, in particular through a perforation line, with a different power or energy curve, simplified, for illustrative purposes only.

FIG. 5 is a block diagram for the application of the correction process, simplified, for illustrative purposes only.

By way of introduction, it should be noted that in the various embodiments, identical parts are provided with identical reference signs or identical component designations, respectively, and the disclosures contained in the entire description can be applied mutatis mutandis to identical parts with identical reference signs or identical component designations, respectively. The positional information selected in the description, such as top, bottom, side, etc., likewise refers to the figure described and is to be transferred to the new position mutatis mutandis in the event of a change of position.

### DETAILED DESCRIPTION OF EMBODIMENTS

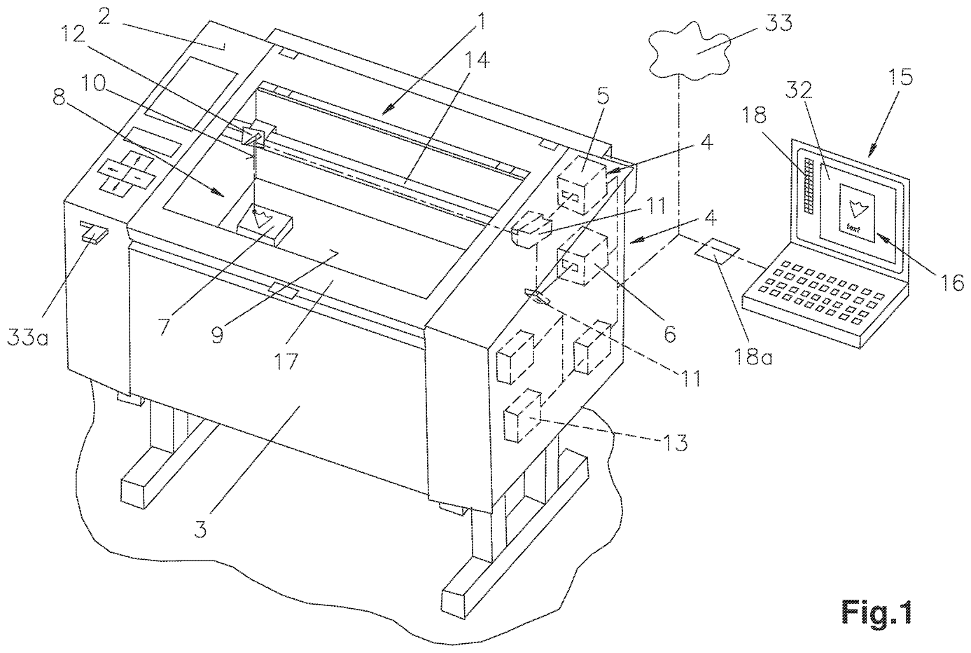

FIGS. 1 to 4 show an exemplary embodiment for a laser device 1, in particular a laser plotter 2 or galvo marking laser 2a, in which a method for producing a perforation 18 on a workpiece 7 for various laser devices 1, in particular laser plotters 2 or galvo marking lasers 2a, for cutting, engraving, marking and/or labeling a workpiece 7, is carried out.

In the laser plotter 2 shown in FIG. 1, at least one, in particular two, beam sources 4 or laser sources 4, respectively, in the form of lasers 5, 6 are arranged in a housing 3. The lasers 5 and 6 preferably act in alternating fashion on the workpiece 7 to be processed. The workpiece 7 is positioned in a processing chamber 8 of the laser plotter 2, in particular on a processing table 9, whereby the processing table 9 is preferably height-adjustable. A laser beam 10 emitted by an irradiation source 4, in particular the laser 4 or 5, is sent via deflection elements 11 to at least one movable focusing unit 12, from which the laser beam 10 is deflected in the direction of the workpiece 7 and focused for processing. Control, in particular the position control of the laser beam 10 in relation to the workpiece 7, is carried out via software running in a control unit 13, whereby the workpiece 7 is processed by adjusting a carriage 14, on which the focusing unit 12 is also movably arranged, preferably via a belt drive in the X-Y direction. Here it is possible, for example, that in the “engraving” machining process, the carriage 14 is moved line by line, whereas in the “cutting” machining process, the carriage is moved according to the contour to be cut, i.e. not line by line.

On an external component 15, in particular a computer or a control unit, a graphic 16 and/or a text 16 is created using commercially available software, such as Coral-Draw, Paint, Ruby, etc., or the user's own application software, in particular Ruby, which is exported or transferred to the controller 13 of the laser device 1 in the form of a job 18a. Preferably, the data to be transferred are converted by the same or a different software so that the controller can process the job 18a. Of course, it is also possible for the input to be made directly on the laser plotter 2 or the galvo marking laser 2a or for a corresponding job 18a to be loaded from a storage medium, such as a cloud 33, a USB stick 33a, etc. After the data, in particular the job 18a, have been transmitted, the laser device 1, in particular its control unit 13, processes the job 18a. Here it is possible to store several jobs 18a simultaneously in the laser device 1, in particular the laser plotter 2 or galvo marking laser 2b, and process them sequentially. For the sake of completeness, it is mentioned that the function described for the laser plotter 2 can be transferred to the galvo marking laser 2a.

In such laser devices 1, it has been customary up to now for a cover 17 or door 17, respectively, which is preferably at least partially transparent, to be closed by the laser device 1 in order to start a job 18a to be processed. Subsequently, the operating staff can position the laser dot or a laser pointer, respectively, manually or automatically to the inserted workpiece 7, whereupon the job 18a for processing the workpiece 7 can be started. Of course, automatic position detection of the inserted workpiece 7 is possible, so that only the workpiece 7 needs to be inserted and the laser device 1, in particular the control unit 13, first determines the position of the workpiece 7 and then processes the job 18a. Usually, however, the workpieces 7 are inserted at a specific position, which is defined by a stop (not shown). At the end of the job 18a, the carriage 14 is then preferably moved to the starting position and stopped, and the finished workpiece 7 can be removed, so that a new machining process can be started. It is advantageous if the end of processing is indicated visually or acoustically so that the user does not have to constantly monitor the laser device 1.

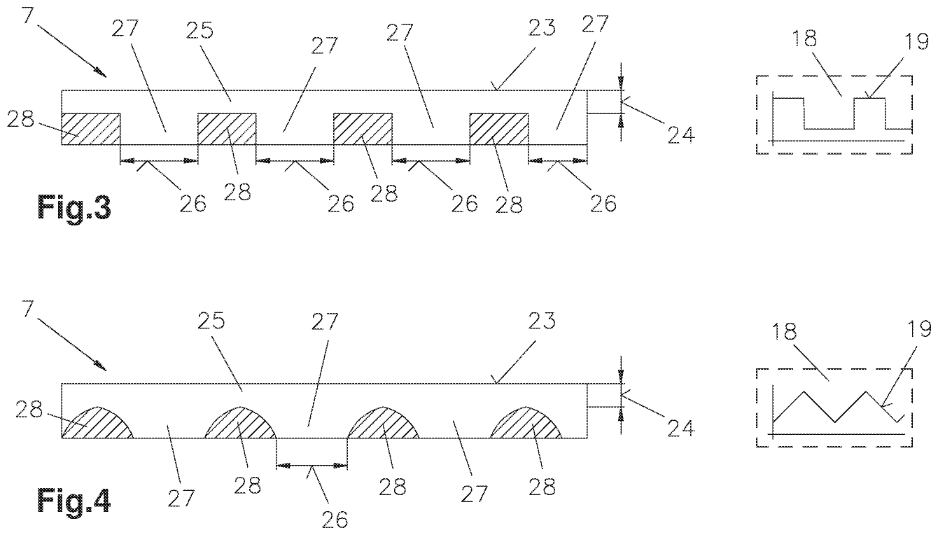

According to the present disclosure, it is now provided that, in order to improve the quality and increase the user-friendliness, the parameter “perforation” 18 has been improved, in which, by selection or transfer or activation, respectively, of the “perforation” option 18, a predefined power or energy curve 19 for the laser 5, 6 as a function of the set power 20 and/or the material type 21 and/or thickness 22 is loaded or used, so that during processing of the workpiece 7 a continuous line or incision 25, respectively, and indentations 27 or penetrations 27 at defined intervals 26 over a defined depth 24 are formed on an upper side 23 of the workpiece 7. This ensures that a continuous line or incision 25, respectively, is visible on the upper side 23 and the workpiece 7 is connected via remaining webs 28, as shown e.g. in FIGS. 3 and 4. The corresponding power and energy curves 19 selected in parameter for workpiece 7 are shown schematically in order to illustrate the differences of the webs 28. Due to the design and shape of the webs 28, the break-out behavior or the break-out force to be applied to the perforation on the workpiece 7, respectively, is influenced, i.e. the smaller the webs 28 are designed, the easier the text 16 and/or graphic 16 can be broken out of the blank 7 or workpiece 7, respectively. For the first time, the user now has the option of influencing the design of the webs 28 by selecting the power and/or energy curve 19.

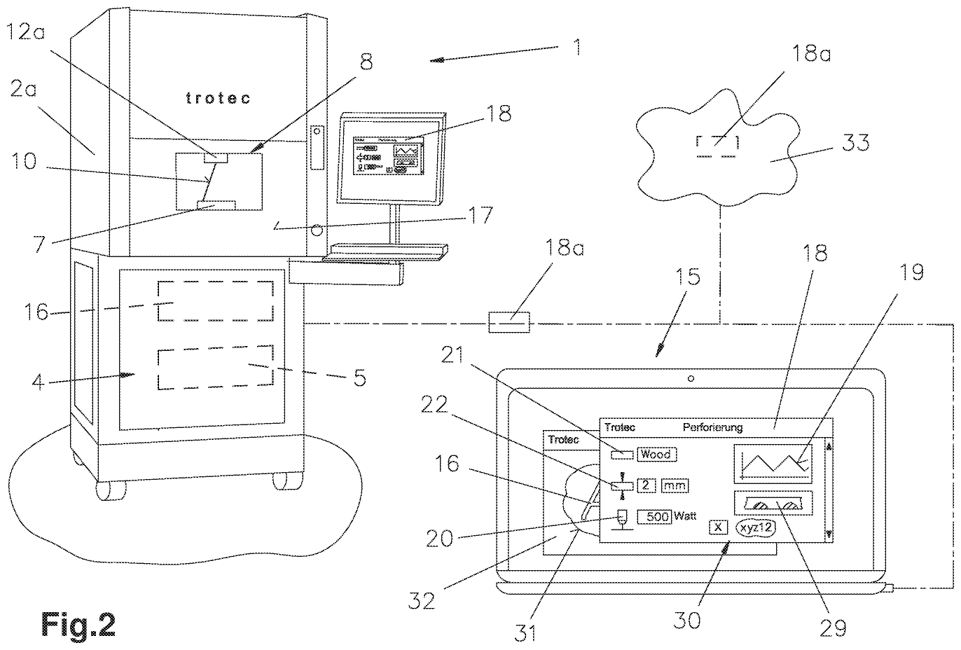

Here it is possible that, in addition to or in lieu of the power and/or energy curve 19, a schematic perforation representation 29 is displayed on the software in the “perforation” parameter 18, as shown in FIG. 2, so that the user can also select the formation correct for him/her based on the formation of the perforation representation 29. Here it is also possible that a higher break-out force is required for larger and narrower webs 28 than would be if smaller webs 28 and fewer of them are selected.

Furthermore, the “perforation 18” parameter or function, respectively, also includes the option of automatically creating a perforation curve 31 running around the outside of the graphic 16 or text 16 by activating an envelope curve 30 parameter, as indicated by an X in the activation box in FIG. 2, as shown schematically in the software interface below the “Perforation” 18 parameter interface in FIG. 2. Here it is possible that the perforation curve 31 can be easily changed with a pointer element, in particular a mouse or the touchpad of the laptop, so that it can be subsequently adapted to the text 16 and/or graphics 16 according to the user's wishes. It is also possible to open a pop-up window when activating the envelope curve 30 by clicking on the pointer element, in which window the user can select further parameters, such as distance to text/graphic 16, shape of the envelope, etc., as this is then created automatically. Such pop-up windows can also be opened for other settings in order to be able to set further options.

For the sake of completeness, it is mentioned that the created job 18a can alternatively be stored in a cloud 33 so that it can be downloaded and processed by a laser device 1 at a later time.

According to the present disclosure, a method for producing a perforation 18 on a workpiece 7 for various laser devices 1, in particular laser plotters 2 or galvo marking lasers 2a, for cutting, engraving, marking and/or lettering a workpiece 7, is disclosed, in which in a housing of the laser plotter 2 one, but preferably several, in particular two beam sources 4 in the form of lasers 5,6 are located, which preferably act in alternating fashion on the workpiece 7 to be processed, whereby the workpiece is deposited in a defined manner on a processing table 8 and a laser beam 10 emitted by the beam source 4 is transmitted via deflecting elements 11 to at least one focusing unit 12 or mirror 12a, from which the laser beam 10 is deflected in the direction of the workpiece 7 and focused for processing, whereby the control is effected via software running in a control unit 13 by processing of a so-called job 18a, in particular transferred or loaded data, wherein the workpiece 7 is processed preferably line by line by adjusting a carriage 14 preferably via a belt drive in the X-Y direction or by adjusting an angle of a mirror 12a, wherein a graphic 16 and/or a text 16 is preferably generated on an external component 15, in particular a computer or a control unit, via a commercially available or proprietary software 32, such as CorelDRAW, Paint, Ruby, etc., which is transferred or exported, respectively, to the control unit 13 of the laser device 1, which performs a conversion of the transferred data, in particular the graphic 16 and/or the text 16, for controlling the individual elements of the laser device 1, wherein by selecting or transferring or activation, respectively, of a “perforation” option 18, a predefined power or energy curve 19 for the laser 5,6 as a function of the set laser power 20, in particular basic power, and/or the material type 21 and/or material thickness 22, is loaded or used, respectively, so that during the processing of the workpiece 7, a continuous line 25 or incision 25, respectively, and, at defined intervals 26, indentations 27 or penetrations 27 are formed on an upper side 23 of the workpiece 7 over a defined depth 24.

Here it is possible for the user to specify a further parameter, namely the incision depth (not shown), to create a continuous line 25 or an incision 25, respectively, on the surface of the workpiece 7. Preferably, this is determined by entering a percentage of the total material thickness 22, so that the laser power 20 is adjusted accordingly by the control unit 13 or the software 32 to create the job 18a. For the sake of completeness, it is mentioned that such additional setting options can preferably be called up and set via a pop-up menu so that the basic input mode remains as simple and clear as possible.

Here it is also possible that various power or energy curves 19 are stored for the different material types 21, which are displayed when the material type 21 is set. Settings, power or energy curves 19 set and specified by the user can also be saved so that they can be called up and reused at any time.

Preferably, it is possible that when the “perforation” 18 function is selected, an additional window of the software 32 opens, in which further parameters that can be set for the perforation 18 are displayed so that they can be changed and saved accordingly by the user. For example, the length of the penetration 27, the length of the webs in between 28, the height of the webs 28 in relation to the total height of the set material thickness 22, etc., can be adjusted.

Furthermore, individual features or combinations of features from the various exemplary embodiments shown and described can also form independent inventive solutions or solutions according to the present disclosure.

1. A method for producing a perforation on a workpiece for various laser devices, in which in a housing, two beam sources in the form of lasers are located, which act in alternating fashion on the workpiece to be processed, whereby the workpiece is deposited in a defined manner on a processing table and a laser beam emitted by the beam sources is transmitted via deflecting elements to at least one focusing unit, from which the laser beam is deflected in the a direction of the workpiece and focused for processing, whereby control is effected via software running in a control unit by processing of a so-called job, wherein the workpiece is processed by adjusting a carriage in the X-Y direction or by adjusting an angle of a mirror, wherein a graphic and/or a text is generated on an external component, which is transferred to the control unit of the laser device, which performs a conversion of the graphic and/or text, for controlling individual elements of the laser device, wherein by selecting or transferring or activation of a “perforation” option, a predefined power or energy curve for the laser as a function of set laser power is loaded such that during the processing of the workpiece, a continuous line or incision is formed on an upper side of the workpiece over a defined depth, and indentations or cuts are formed at defined intervals.

2. The method according to claim 1, wherein power adjustment of the laser to a set parameter “material thickness” is carried out, such that the continuous line or incision is produced on a surface of the workpiece over a set depth.

3. The method according to claim 2, wherein a parameter “depth” in relation to a parameter “perforation”, specifies a percentage value in relation to the parameter “material thickness” (22), such that an automatic calculation of an actual depth is carried out before or at a start of the process.

4. The method according to claim 1, wherein several different power or energy curves are stored for forming differing perforations, one of which is selected before the workpiece is processed.

5. The method according to claim 1, wherein a power or energy curve is stored by PWM signals with differing pulse heights and pulse lengths.

6. The method according to claim 1, wherein power or energy curves with rectangular curves with different pulse heights and pulse lengths are stored.

7. The method according to claim 1, wherein when the graphic and/or the text is created, the power or energy curve for the perforation is stored or saved by selecting a defined property.

8. The method according to claim 1, wherein an automatic analysis process for the graphic and/or text is carried out by selecting the “perforation” option, in which all outer edges of the graphic and/or text or a closed contour with a defined offset to the enclosed object is identified or changed as the line type for the perforation.

9. The method according to claim 1, wherein a variety of line types are stored in the software and can be selected.

10. A laser plotter for engraving, marking and/or labeling a workpiece, comprising a processing chamber for positioning the workpiece, at least two beam sources in the form of lasers with corresponding deflection elements and a movable focusing unit and a control unit for controlling a carriage operated via a belt drive with the focusing unit arranged movably thereon, wherein control upon activation of selection of a “perforation” option for operating the lasers is designed with a power or energy curve in which a continuous line and indentations or penetrations at defined intervals are formed on a surface of the workpiece.

11. The laser plotter according to claim 10, wherein the laser plotter is designed for producing the perforation on the workpiece.

12. The laser plotter according to claim 10, wherein the laser plotter is a Galvo marking laser.

13. The laser plotter according to claim 12, wherein the galvo marking laser is designed for producing the perforation on the workpiece.

14. A method for producing a perforation on a workpiece for various laser devices in which in a housing of a laser plotter two beam sources in the form of lasers are located, which act in alternating fashion on the workpiece to be processed, whereby the workpiece is deposited in a defined manner on a processing table and a laser beam emitted by the beam sources is sent to at least one focusing unit via deflection elements, from which the laser beam is deflected in a direction of the workpiece and focused for processing, whereby control is effected via software running in a control unit by processing transferred or loaded data, wherein the workpiece is processed line by line by adjustment of a carriage via a belt drive in the X-Y direction or by adjustment of an angle of a mirror, wherein a graphic and/or a text is generated on an external component, which is transferred or exported to the control unit of the laser device, which performs a conversion of the transferred data for controlling individual elements of the laser device, wherein by activating a parameter for a “perforation envelope curve”, a perforation line running around the graphic and/or text at a a constant distance, is automatically created.

15. The method according to claim 14, wherein a distance of a circumferential perforation line can be adjusted or the perforation line is manually shifted on the software.

16. The method according to claim 14, wherein a shape of the perforation line is preset.
